(19) United States
(12) Patent Application Publication
(10) Pub. No.: US 2005/0112921 A1
(43) Pub. Date: May 26, 2005

(54) Cable grounding clamp

(76) Inventors: Yi-Sheng Lin, Tu-Chen (TW); YangChu Guo, Kunsan (CN)

Correspondence Address: WEI TE CHUNG;FOXCONN INTERNATIONAL, INC., 1650 MEMOREX DRIVE, SANTA CLARA, CA, 95050, US

(21) Appl. No.: 10/994,083

(22) Filed: Nov. 19, 2004

(30) Foreign Application Priority Data
Nov. 22, 2003 (CN) 200320119982.3

(51) Int. Cl. H01R 4/66

(52) U.S. Cl. 439/98

(57) ABSTRACT

A cable grounding clamp (10) includes a first grounding sheet (11), a second grounding sheet (12) and a connecting portion (13) connecting the first and the second grounding sheets. The first and the second grounding sheets respectively define a first and a second circular openings (110, 120) in the centers thereof. The connecting portion forms a passage (14) for receiving a cable (230). After the cable protrudes through the passage of the cable grounding clamp, a bolt (16) protrudes through the first and the second circular openings to engage with a printed circuit board (25). The connecting portion defines a soldering slot (130) therein, which facilitates the soldering process between the cable grounding clamp and metal braiding of the cable.

### BACKGROUND OF THE INVENTION

1. Field of the Invention

The present invention generally relates to a cable grounding clamp, and more particularly to an improved cable grounding clamp for achieving more reliable clamping and quick grounding functions.

2. Description of Related Art

Conventional manners for grounding a cable connector to protect against the interference from useless electric current are to connect the grounding lead to the shielding shell or to the grounding terminals of the cable connector. However, the resistance of the grounding lead is a little higher because of smaller diameter and longer length in some situations, especially as the cable connector requires quick and direct grounding.

Cable grounding clamps for cables have been employed in the past to clamp the cables and been attached to grounding leads to form a grounding path. However, there are many situations that require a firmer clamping function of the cable grounding clamps and a quicker grounding function of the grounding conductor lead.

Hence, an improved cable grounding clamp is required to overcome the disadvantages of the above grounding manners and the fore cable grounding clamps.

### SUMMARY OF THE INVENTION

Accordingly, a first object of the present invention is to provide a cable grounding clamp achieving quick and direct grounding functions.

A second object of the present invention is to provide a coaxial cable grounding clamp defining a soldering slot which facilitates the soldering process between the cable grounding clamp and metal braiding of the cable.

Another object of the present invention is to provide an assembly including a cable grounding clamp, a cable and a printed circuit board to form a short grounding path and to have a better grounding function.

In order to achieve the objects set forth, a cable grounding clamp in accordance with the present invention comprises a first grounding sheet, a second grounding sheet and a connecting portion connecting the first and the second grounding sheets. The first and the second grounding sheets respectively define a first and a second circular openings in the center thereof. The connecting portion defines a soldering slot therein which facilitates the soldering process between the cable grounding clamp and metal braiding of the cable. Additionally, the connecting portion forms a passage for receiving a cable of a cable connector. After the cable protrudes through the passage of the cable grounding clamp, a bolt protrudes through the first and the second circular openings to engage with a printed circuit board, thus, the first and the second grounding sheets are tighten on the printed circuit board. Then, the two lateral edges of the soldering slot are soldered with the cable, so the cable grounding clamp is further contracted into security engagement with the cable.

Other objects, advantages and novel features of the invention will become more apparent from the following detailed description when taken in conjunction with the accompanying drawings.

### BRIEF DESCRIPTION OF THE DRAWINGS

FIG. 1 is a perspective view of a cable grounding clamp in accordance with the present invention;

FIG. 2 is a cross-sectional view of the cable grounding clamp taken along line 2-2 of FIG. 1;

FIG. 3 is a perspective view of a case for portable storage with the cable grounding clamp therein;

FIG. 4 is a partially exploded, perspective view of the case for portable storage as shown in FIG. 3;

FIG. 5 is a partially assembled view of FIG. 4;

FIG. 6 is an enlarged view of a circled part shown in FIG. 5; and

FIG. 7 is an exploded, perspective view of FIG. 5.

### DETAILED DESCRIPTION OF THE INVENTION

Reference will now be made in detail to the preferred embodiment of the present invention.

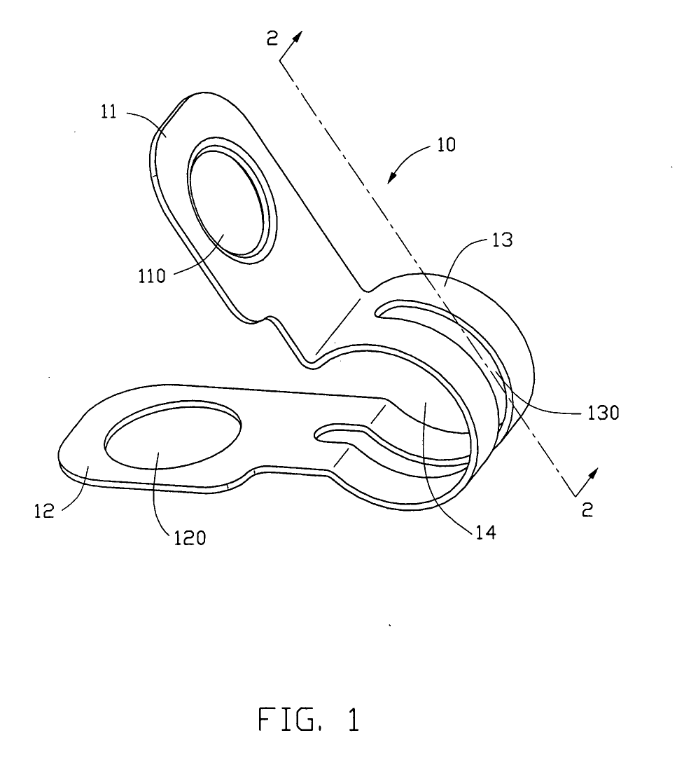

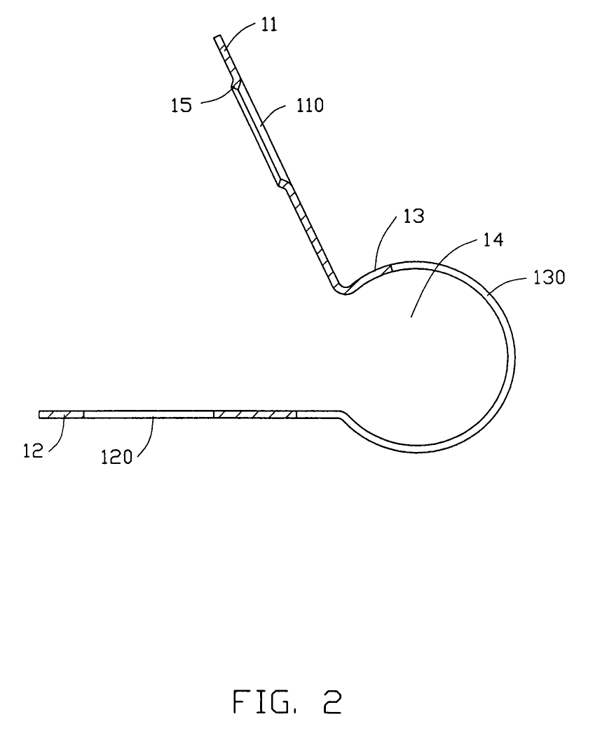

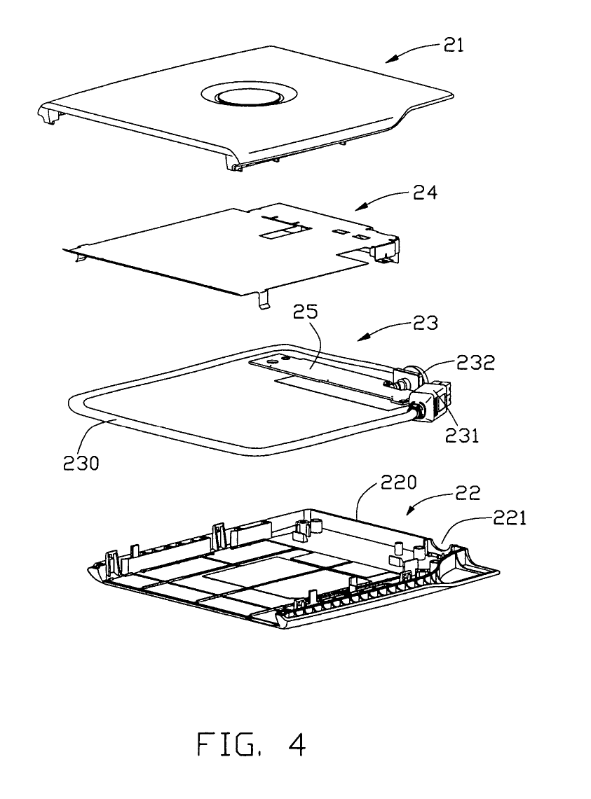

Referring to FIG. 1 and FIG. 2, a cable grounding clamp 10 in accordance with the present invention includes a first grounding sheet 11, a second grounding sheet 12 and a connecting portion 13 connecting the first grounding sheet 11 with the second grounding sheet 12. A soldering slot 130 is defined in a center of the connecting portion 13 along a peripheral of the connecting portion 13 and partially extends into the second grounding sheet 12. The first and the second grounding sheets 11, 12 respectively define a first and a second circular openings 110, 120 in the center thereof, and the diameter of the first circular opening 110 is smaller than that of the second circular opening 120. An inner annular projection 15 is stamped with the first grounding sheet 10 and projects toward the second grounding sheet 12 from a peripheral of the first circular opening 110. The connecting portion 13 forms a passage 14 for receiving a cable 230 of a cable assembly 23 (FIG. 4).

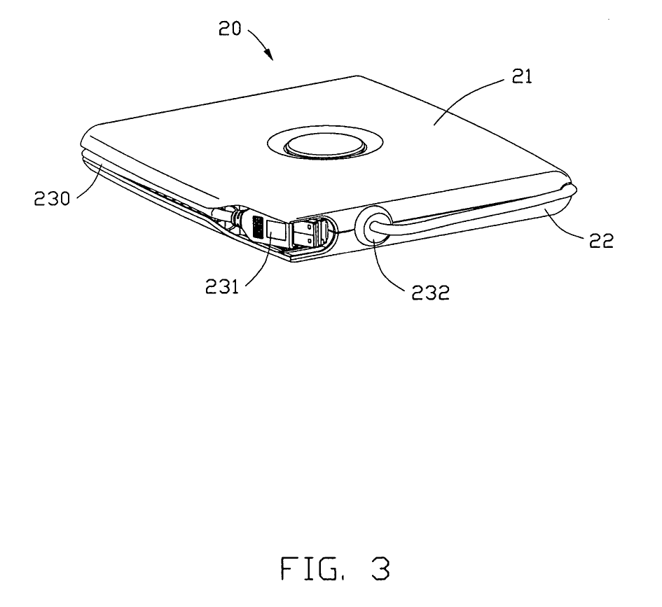

Referring to FIG. 3, a case 20 for portable storage having the cable grounding clamp 10 in accordance with the present invention is shown.

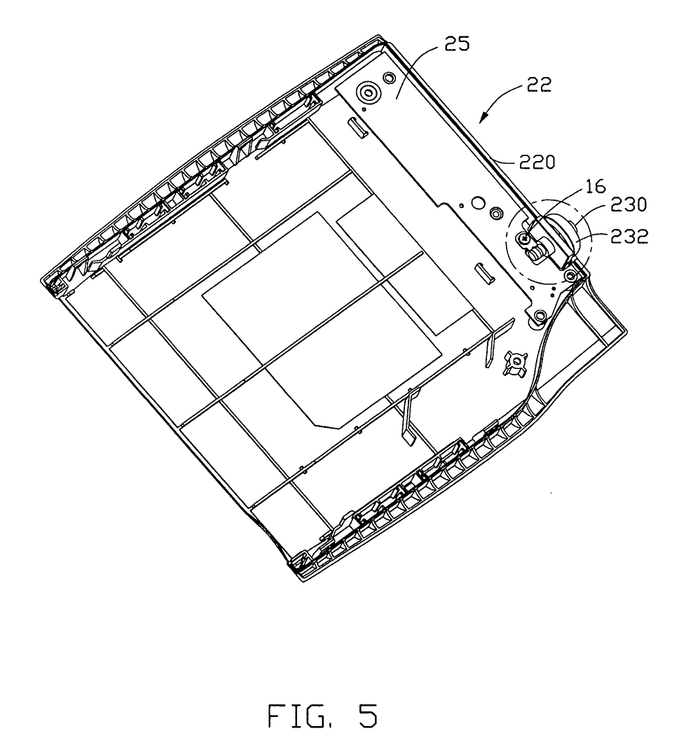

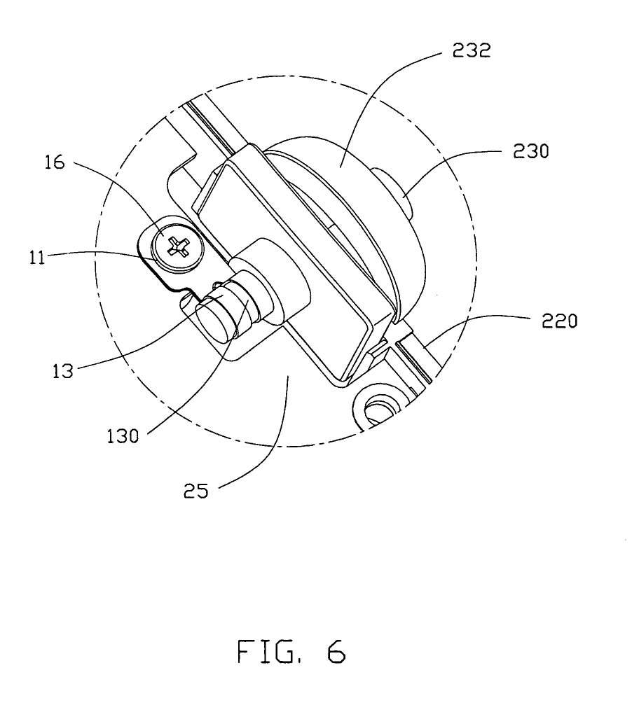

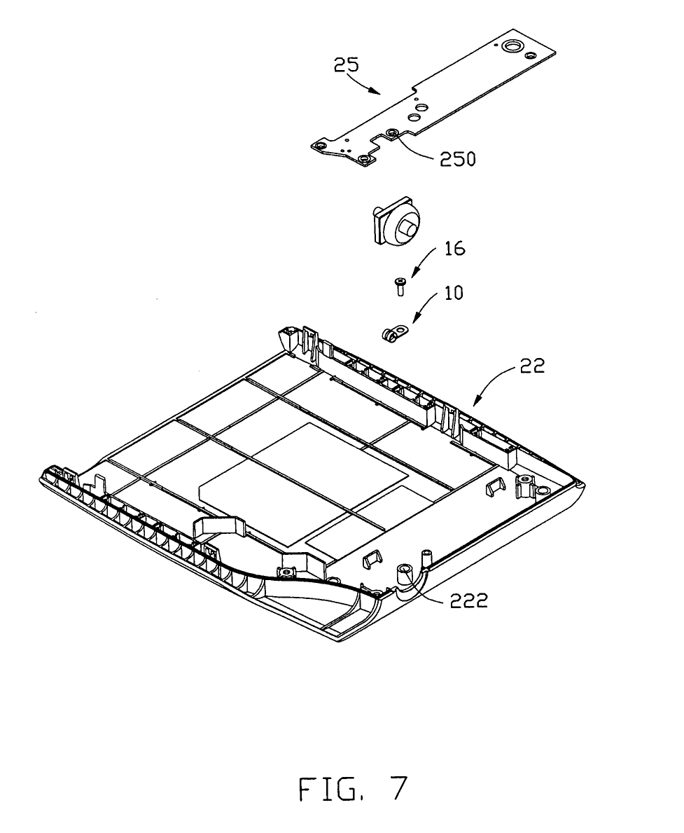

To show the assembled relationship among the cable grounding clamp 10, the cable 230 of the case 20 and a printed circuit board 25 more clearly, an electrical connector mounted on the printed circuit board 25 and a tap of the cable 230 soldered with the printed circuit board 25 are not presented in FIG. 4 and FIG. 5. Referring to FIGS. 4 to 7, the case 20 for portable storage includes a top cover 21, a bottom cover 22, the cable assembly 23, a shielding shell 24, a printed circuit board 25, the cable grounding clamp 10, and a bolt 16 for securing the cable grounding clamp 10 to the printed circuit board 25. The top cover 21 has a structure similar to that of the bottom cover 22. Each of the top and the bottom covers 21, 22 has a front wall 220 defining a semicircular opening 221. The difference between the top and the bottom covers 21, 22 is that the bottom cover 22 forms a post 222 (FIG. 7) defining a thread hole for fixation of the bolt 16. The printed circuit board 25 defines a plurality of fixing openings (not labeled) and a screw hole 250 mating with the bolt 16. The cable assembly 23 includes the tap (not shown) for soldering on the printed circuit board 25, the cable 230 exposed out of the front wall 220, and a cable connector 231 connecting with a free end of the cable 230 outside the case 20 for portable storage. The cable 230 has a securing portion 232 on the other free end which connects with the printed circuit board 25.

Referring to FIGS. 3 to 7, in assembly of the cable grounding clamp 10 and the cable assembly 23, the cable 230 protrudes through the passage 14 of the cable grounding clamp 10. Then the bolt 16 protrudes through the first and the second circular openings 110, 120 respectively to engage with the printed circuit board 25. Thus, the first and the second grounding sheets 11, 12 are tightened on the printed circuit board 25. Finally, two lateral edges of the soldering slot 130 are soldered with the metal braiding (not shown) of the cable 230, so the cable grounding clamp 10 is contracted into firm engagement with the cable 230 and a grounding path for the cable assembly 23 is formed.

In assembly, the first and the second grounding sheets 11, 12 engage with each other quickly because the diameter of the first circular opening 110 is smaller than that of the second circular opening 120 and the inner annular projection 15 of the first circular opening 110 is received in the second circular opening 120 firmly. The soldering slot 130 increases the soldering area between the cable 230 and the cable grounding clamp 10 and makes the soldering more conveniently. Thus, the soldering connection between the cable grounding clamp 10 and the cable 230 is much more reliable and the cable 230 has no possibility of loosening from the cable grounding clamp 10 when the case 20 subjects to vibration, a shock, or other accidental issue. In addition, the metal braiding of the cable 230 is grounded to the printed circuit board 25 by the structure of the cable grounding clamp 10 through a short path.

As the case 20 for portable storage being assembled, the cable assembly 23 is soldered with a corresponding tab of the printed circuit board 25 to secure the cable assembly 23 to the printed circuit board 25. The printed circuit board 25, the cable grounding clamp 10 and the other free end of the cable 230 are assembled closely to the front wall 220 of the case 20. The shielding shell 24 is assembled below the bottom face of the top cover 21 and against the front wall 220. The top and the bottom covers 21, 22 engage with each other and form a space (not labeled) for receiving the cable grounding clamp 10, the printed circuit board 25 and other elements. After the top and the bottom covers 21, 22 combined, the semicircular openings 221 on the top and the bottom covers 21, 22 form a circle opening through which the fixation portion 232 of the cable assembly 23 protrudes.

It is to be understood, however, that even though numerous characteristics and advantages of the present invention have been set forth in the foregoing description, together with details of the structure and function of the invention, the disclosure is illustrative only, and changes may be made in detail, especially in matters of shape, size, and arrangement of parts within the principles of the invention to the full extent indicated by the broad general meaning of the terms.

1. A cable grounding clamp adapted for grounding a cable connector mounted on a PCB, comprising:
a first and a second grounding sheets opposite to each other, each grounding sheet defining a circular opening;
a connecting portion connecting said first and said second grounding sheets and defining a passage there through; and
a soldering slot defined in and extending along said connecting portion.

2. The cable grounding clamp as said in claim 1, wherein the diameter of the circular opening of the first grounding sheet is smaller than that of the circular opening of the second grounding sheet.

3. The cable grounding clamp as said in claim 1, wherein said circular opening of the first grounding sheet defines an inner annular projection engaged with the circular opening of the second grounding.

4. The cable grounding clamp as said in claim 3, wherein the diameter of said inner annular projection is smaller than that of the circular opening of the first grounding sheet.

5. The cable grounding clamp as said in claim 1, wherein the soldering slot is defined in the middle of the connecting portion and extends along a peripheral of the connecting portion.

6. The cable grounding clamp as said in claim 5, wherein the connecting portion is arc-shaped.

7. An assembly comprising:
a cable having a metal braiding;
a printed circuit board having a grounding path; and
a cable grounding clamp comprising:
a first and a second grounding sheets oppositely fixed on the printed circuit board and forming electrical connection with the grounding path;
an arcuate connecting portion connecting said first and said second grounding sheets and electrically connecting with the metal braiding of the cable, the arcuate connecting portion defining a passage for the cable protruding therethrough; and
a bolt for fixing said cable grounding clamp on said printed circuit board.

8. The assembly as said in claim 7, wherein the first and the second grounding sheets of the cable grounding clamp respectively define a circular opening.

9. The assembly as said in claim 8, wherein said circular opening of the first grounding sheet defines an inner annular projection engaged in the circular opening.

10. The assembly as said in claim 7, wherein the arcuate connecting portion of the cable grounding clamp defines a soldering slot.

11. The assembly as said in claim 10, wherein said printed circuit board defines a screw hole for mating with the bolt.

12. The assembly as said in claim 11, further comprising a case for receiving the cable, the printed circuit board, the cable grounding clamp and the bolt.

13. The assembly as said in claim 12, wherein said case defines a post for mating with the bolt.

14. An assembly comprising:
a cable having a metal braiding;
a printed circuit board having a grounding path; and
a cable grounding clamp comprising:
at least one grounding plate supportably seated and fixed on the printed circuit board and forming electrical connection with the grounding path;
an arcuate connecting portion defining one end integrally extending from said grounding plate and electrically connecting with the metal braiding of the cable, the arcuate connecting portion defining a passage for the cable protruding therethrough; wherein
the metal braiding and said arcuate connecting portion own over half circular circumferential engagement therebetween.

15. The assembly as claimed in claim 14, wherein said circumferential engagement is essentially of one circle.

16. The assembly as claimed in claim 15, wherein another grounding plate is integrally connected to the other end of the arcuate connecting portion and opposite to said at least grounding plate in a parallel relation.

17. The assembly as claimed in claim 16, wherein said another grounding plate is fixed to the printed circuit board.

18. The assembly as claimed in claim 17, wherein said another grounding plate and said at least one grounding plate are respectively positioned on two opposite surfaces of the printed circuit board.
